(19) United States
(12) Patent Application Publication
(10) Pub. No.: US 2005/0232384 A1
(43) Pub. Date: Oct. 20, 2005

(54) Method for the synchronization of subscribers of a network

(75) Inventors: Andreas Heid, Ludwigsburg (DE); Andreas Kraut, Ludwigsburg (DE); Steffen Schwips, Kirchberg an der Murr (DE)

Correspondence Address: Thomas E. Hill;Emrich & Dithmar LLC, Suite 2080, 125 S. Wacker Drive, Chicago, IL, 60606-4401, US

(73) Assignee: Jetter AG

(21) Appl. No.: 11/112,516

(22) Filed: Apr. 22, 2005

(30) Foreign Application Priority Data
Oct. 14, 2003 (WO) PCT/DE03/03406
Oct. 22, 2002 (DE) 102 49 296.4

(51) Int. Cl. H04B 7/216

(52) U.S. Cl. 375/354

(57) ABSTRACT

According to the invention, a time emitter of a subscriber (1) provided as a reference in a network regularly and/or randomly transmits reference time signals (TR1). A subscriber (2) approximately adjusts the local time measurement thereof in relation to the time measurement of the reference subscriber (1) only if the difference between the reference time (TR) and local time (TL) is less than a predetermined or predeterminable threshold value (e), at the moment when the reference time signal is received and/or a signal path is kept clear between the subscriber (2) and the reference subscriber (1) or the network for instantaneous data transmission.

The invention relates to a method for the synchronization of local timers of subscribers and/or processors of a network, in particular of a segmented network or process control network, with a timer of a subscriber or server that is predefined or predefinable as a reference in the network, which regularly and/or stochastically transmits reference time signals or data packets comprising such signals, it being possible for unforeseeably variable data transmission times to occur in the network, inter alia caused by varying loading and/or an altered structure of the network and of its subscribers, in particular at network nodes, and/or varying signal paths.

For a disturbance-free cooperation of the subscribers of a network, it is regularly necessary or at least advantageous for the subscribers to be synchronized with a common system time, i.e. a uniform time of day is “agreed” for a subscriber. Only in this way is it possible for a subscriber to make available data packets or signals that are required for other subscribers at an agreed instant or within an agreed time interval.

The fundamental difficulty in the synchronization of a network is that no network levels reserved exclusively for specific items of information are routinely available between the subscribers. Rather, the signal paths between the subscribers are used in principle for data packets having an arbitrary information content. The consequence of this is that data packets transmitted by a subscriber will probably be delayed to a greater or lesser extent en route to the addressed subscriber, i.e. the data transmission times between two subscribers cannot be predicted reproducibly. This may for example be based on the fact that data packets have to be buffer-stored at network nodes in order to be able to ensure a collision-free data transmission in the line paths connected to said network nodes. If a collision-free data transmission is not ensured in the respective network or subnetwork, delays may also occur as a result of the fact that data packets that collide with one another regularly cannot be correctly evaluated by the respectively addressed subscribers and therefore have to be communicated anew by the originator subscriber.

Irrespective of the cause of the possible delays during data communication, it can probably be assumed, however, that a considerable proportion of communicated data will reach the respectively addressed subscriber without any delays even in the case of relatively high network loading. However, the prior art has not demonstrated any possibility as to how, in a network with unforeseeably variable signal propagation times, it could be ascertained whether or not a data packet has been exchanged between two subscribers without any delays.

In order nevertheless to be able to carry out a synchronization with high accuracy, a concept has been developed which enables signal propagation times to at least be estimated.

In accordance with WO 01/9550 A2, it may be provided, by way of example, that a subscriber requests a reference time from the reference subscriber or server at an instant T₁ determined by the local timer of the aforementioned subscriber. The data packet which is transmitted by the subscriber for this purpose and contains an item of information concerning the time T₁ is received by the reference subscriber or server at an instant T₂ determined by the timer thereof. At an instant T₃ determined by the timer of the reference subscriber or server, the reference subscriber or server then transmits to the aforementioned subscriber a data packet with the information that the data packet transmitted at the instant T₁ was received at the instant T₂. This data packet additionally contains the transmission time T₃. The aforementioned subscriber may then receive this data packet at an instant T₄ established by its timer.

The subscriber can thus estimate the propagation time d for the data communication from the subscriber to the reference subscriber or server and from the reference subscriber or server to the subscriber as follows.
d=(T₄−T₁)−(T₃−T₂)
Moreover, the time shift t between the timer of the subscriber and the timer of the reference subscriber or server can be estimated as follows:
2 t=T₂−T₁+T₃−T₄.
As a result, the time of day of the timer of the subscriber can be matched to the time of day of the timer of the reference subscriber or server. However, a certain inaccuracy will probably remain because it cannot be ensured that the signal propagation times on the path from the subscriber to the reference subscriber or server, on the one hand, and the path from the reference subscriber or server to the subscriber, on the other hand, are of the same magnitude.

Further causes of inaccuracies are also manifested. By way of example, additional inaccuracies occur when the data, with respect to the instants T₁ to T₄, have different positions within the data packets comprising these information items.

In order to be able to compensate for this inaccuracy, provision is made, in accordance with WO 01/95562 A2, for time information items to be placed in each case at the start of a data packet and, moreover, for data packets with time information items to be transmitted only after a short delay time has elapsed after the start of transmission of a preceding data packet. This makes it possible, on the one hand, for the transmission time of the data packet with time information to be predetermined very precisely, so that the time information contained in the data packet, also called a time stamp, corresponds very exactly to the actual transmission time as is determined by the timer of the respective transmitting subscriber. Moreover, delays due to parts of the data packet containing the time information which precede the respective time information are avoided.

For further improvement of the synchronization, it has already been proposed for data to be exchanged multiply repeatedly between a subscriber and the reference subscriber or server, so that correspondingly many values are available for the propagation time d and also the time of day difference t. Only the time of day difference t is then taken into account, this difference being assigned to the smallest value of the signal propagation time d.

Although the best possible synchronization in each case can be carried out in this way, it nevertheless remains uncertain whether the degree of accuracy achieved is actually good.

Finally, the document IEE 47 (2002) No. 7, page 52 et seq., discloses carrying out synchronizations in bus systems as far as possible when all bus subscribers are connected and addressable. To express it in a simplified way, then, the bus is intended to be enabled for the respective synchronization in order to avoid signal delays.

It is an object of the invention, then, to provide a new synchronization method which is distinguished by very high, practically arbitrarily increasable accuracy and is suitable for practically arbitrary networks, in particular also Ethernet systems.

This object is achieved by virtue of the fact that, in the case of the method specified in the introduction, a subscriber approximates or matches its local time measurement to the time measurement of the reference subscriber or server only when the difference between reference time and local time, at the instant of reception of the reference time, is smaller in magnitude than a predefined low threshold value and/or a signal path between subscriber and reference unit or server or the network is kept free for delay-free signal communication.

The invention firstly makes use of the fact that it is regularly possible, e.g. by means of known synchronization methods, to achieve a standard synchronization that has only small residual synchronization errors.

This is essentially tantamount to stating that the synchronization errors that then remain, which are manifested in residual deviations of the local time of a subscriber from the reference time, are comparatively small.

Furthermore, the invention is based on the insight that such residual errors can be corrected only when time signals (GONG STROKE signals) pass from the reference subscriber or server to the subscriber to be synchronized without any delay or at least without any appreciable delay. By virtue of the predefinition—provided according to the invention—of a threshold value for the magnitude of the deviation at which the local time of a subscriber is permitted to be altered, a sufficient condition can then be predefined with regard to the fact that the GONG STROKE signal must have reached the respective subscriber without any delays and this subscriber can correctly compensate for the residual synchronization error that is present in each case.

Moreover, the invention makes use of the fact that even in severely loaded networks, data packets can be exchanged between the subscribers without any delays. Even in the case of a threshold value that is dimensioned to be small with regard to an extreme synchronization quality, there is a high probability that each subscriber will often be able to receive GONG STROKE signals in the case of which the reference time is close to the local time, so that these signals can be used for the synchronization of the local timer in the manner according to the invention.

In addition or as an alternative, provision may be made for keeping free a signal path between a subscriber to be synchronized and the reference subscriber or server for delay-free signal communication, in order to be able to correct relatively large synchronization errors or to expedite the aforementioned synchronization measures. In this context, provision may be made, in particular, for keeping free signal paths or preferably the entire network for delay-free signal communication in a predefined or predefinable temporal cycle.

In accordance with an advantageous variant of the invention, provision may also be made for taking into account in each case only a fraction of the difference that occurs between reference time and local time in the alteration of the local time measurement, in which case said fraction should be greater, the smaller the difference between local time and reference time.

In the case of this procedure, the threshold value specified above may be dimensioned to be comparatively large, so that the synchronization of a subscriber can also take account of those GONG STROKE signals which have incurred a “moderate” delay en route from the reference subscriber or server to the subscriber to be synchronized. Since such delays occur only with limited frequency and, as a result, make up only a fraction of the respective correction of the local timer, a swift approximation of the local time to the reference time will probably be ensured.

One variant of the invention provides for the subscriber that is respectively to be synchronized to acknowledge reception of the GONG STROKE signal to the reference subscriber or server. It is thus possible to determine the time duration between transmission and acknowledgement (“echo signal”) of the GONG STROKE signal, and the subscriber is permitted to match or approximate the local time to the reference time only when the aforementioned time period falls below a predefined or predefinable maximum value.

Said maximum value, taking account of the reaction time of the subscriber for carrying out the aforementioned acknowledgement, may be dimensioned to be so tight that, in the case where the maximum value is undershot, both the communication of the GONG STROKE signal from the reference subscriber or server to the subscriber and the latter's communication of the echo signal to the reference subscriber or server must have taken place without any delays. The fact of the aforementioned maximum value being undershot or complied with is thus a sufficient condition with regard to the fact that the subscriber to be synchronized actually improves its degree of synchronization if it approximates the local time to the reference time communicated.

Moreover, with regard to advantageous features of the invention, reference is made to the claims and also the following explanation of the drawing, on the basis of which particularly advantageous embodiments of the invention are described in more detail. In this case, it goes without saying that the invention is not restricted to the combinations of features expressly claimed or described, rather protection is claimed for all novel individual features or subcombinations of the combinations of features explicitly illustrated in the description or in the claims.

In the figures:

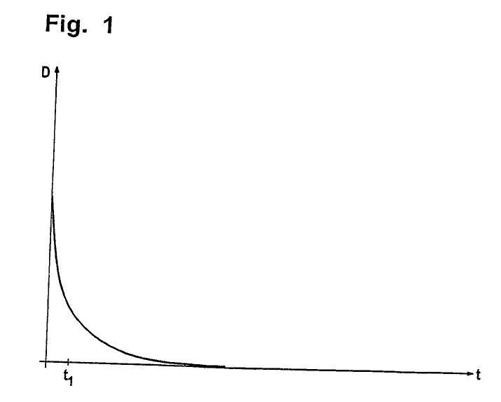

FIG. 1 diagrammatically shows the frequency density (D) for the occurrence of a delay as a function of the delay time (t) incurred by a data packet en route between two subscribers of a network,

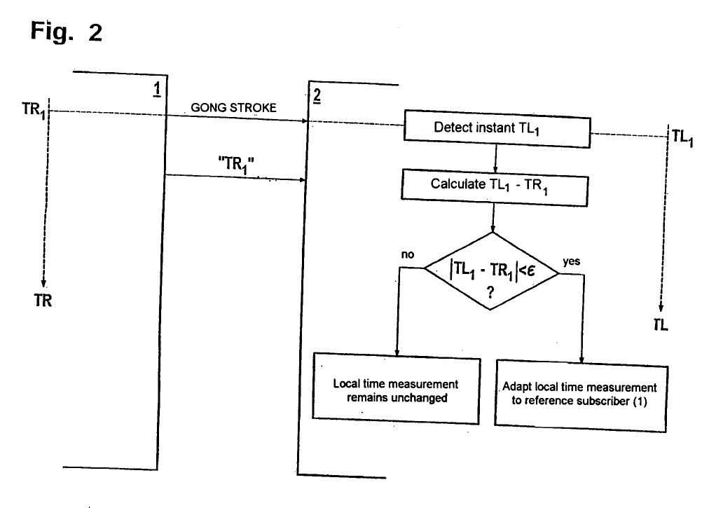

FIG. 2 shows a method for synchronization which is particularly preferred according to the invention,

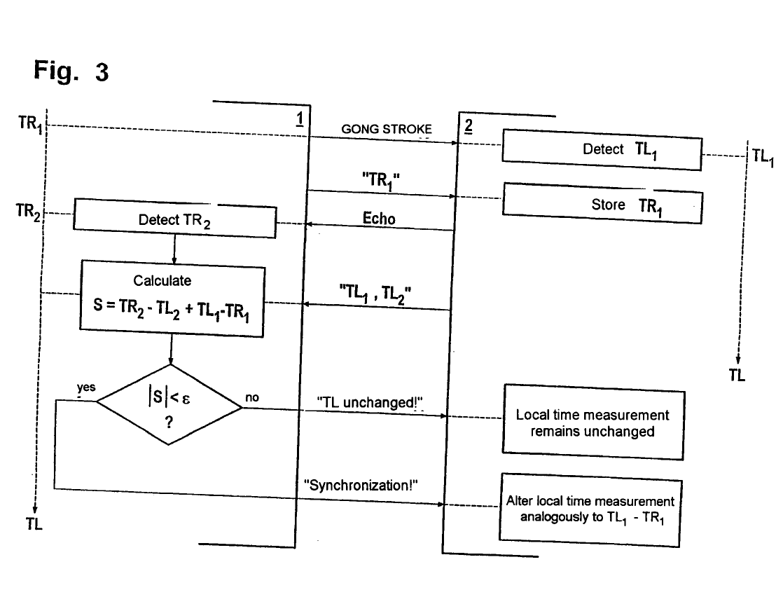

FIG. 3 shows a synchronization method according to the invention that is modified and/or carried out additionally, and

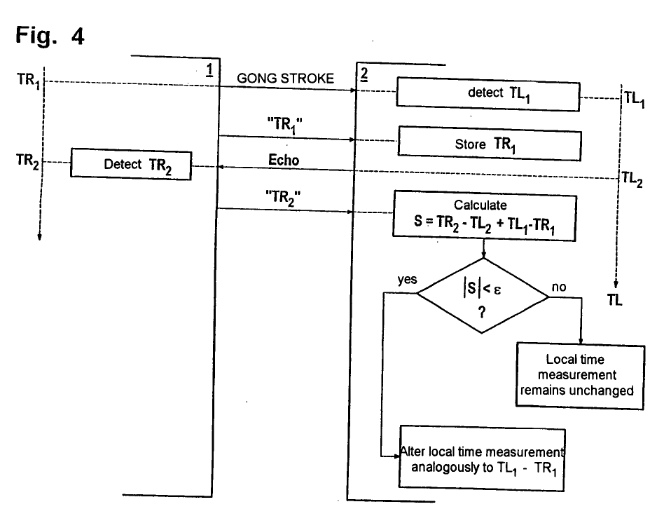

FIG. 4 shows a variant of the method of FIG. 3.

In a network (not specifically illustrated), a data packet may be communicated from one subscriber to another subscriber. In the case of communication by means of electromagnetic signals, the signal speed corresponds to the speed of light; that is to say that in the case of a spatially delimited network, for instance a process control network, the length of a signal path is extremely small in comparison with the signal speed, so that the signal speed hereinafter can be assumed to be “infinite”, to an approximation.

Nevertheless, the aforementioned data packet will probably not traverse the path from one subscriber to the other subscriber without any delays. Rather, a delay time t will probably occur, which is dependent inter alia on the loading of the network and the number of network nodes traversed by the data packet.

FIG. 1, then, qualitatively illustrates the probability density D for the occurrence of a temporal delay as a function of the delay time t. Even in the case of relatively severely loaded networks and a large number of network nodes on a data packet's path between two subscribers, the probability density D has a large dimension or a pronounced maximum for a vanishing delay time, i.e. for t=0.

The curve representing the probability density D has a form such that the integral of the probability density D over the time period t=0 to t=∞ has the value “1”.

The probability w(t₁) of the delay time that actually occurs being less than t₁ is

$$w ( {t}_{1} ) = {\int }_{0}^{{t}_{1}} D ( t ) ⅆ t$$

Even when a process control network is severely loaded, large probability values occur for small delay times. A delay-free transmission of a data packet is thus a comparatively frequent event.

The invention makes use of this in the synchronization of the local timer (not illustrated) of a subscriber with the reference timer of a reference subscriber or server.

FIG. 2 schematically illustrates a reference server 1, which has the task, inter alia, of synchronizing a subscriber 2, which is likewise only illustrated schematically, or the local timer (not illustrated) of said subscriber with the reference timer (not illustrated) of the server 1. It shall be assumed that a relatively good synchronization has already been achieved. Accordingly, the local time TL of the subscriber 2 corresponds to the reference time TR of the reference server 1 apart from a maximum deviation δ, i.e.
TR±δ−TL.

At regular intervals or at a reference instant TR₁, for the purpose of synchronizing subscribers, in this case the subscriber 2, the server 1 then passes into the network a GONG STROKE signal and immediately afterward or somewhat later a data packet with the aforementioned time TR₁. The GONG STROKE signal arrives at the subscriber 2 at the instant TL₁, which is determined by the local timer of the subscriber 2. The subscriber 2 “identifies” the transmission instant of the GONG STROKE signal from the subsequent data packet with the time TR₁.

If the GONG STROKE signal has been communicated to the subscriber 2 practically without any delays, the following must hold true for a small threshold value:
−ε<TR₁−TL₁<+ε.
If this condition is met, the speed of the local timer of the subscriber 2 is corrected by an amount dependent on the difference between TR₁ and TL₁. If the aforementioned condition was not met, the local timer is not corrected.

Thus, use is made of the fact that, given a sufficiently small value of ε, it is very highly probable that the respective GONG STROKE signal has been transmitted without any delays and the subscriber 2 to be synchronized is accordingly permitted to “believe” the reference time communicated and to carry out a corresponding correction of the local timer. As soon as the difference between reference time and local time is greater than the value of ε, the transmission of the GONG STROKE signal was not free of delays. In this case, therefore, the subscriber 2 is not permitted to believe the reference time and, accordingly, is not permitted to correct the local timer either.

On account of the fact explained above that delay-free data communications occur relatively frequently, the subscriber 2 can correspondingly frequently match its local timer to the reference timer. Since timers are usually crystal-controlled and have a high accuracy anyway, the local time of the subscriber 2 can only incur a very small shift relative to the reference time until the next synchronization correction. As a result, an extremely high degree of synchronization can thus be established.

It should be emphasized that only the respective GONG STROKE signal has to be communicated “without any delays” for the synchronization measures according to the invention. By contrast, the associated data packet with the reference time TR₁ is permitted to be delayed during its communication.

FIG. 3 then shows a synchronization method in which the reference server 1 checks whether a GONG STROKE signal communicated to a subscriber 2 at an instant TR₁ for the purpose of synchronization has been communicated without any delays, i.e. the server 1 checks whether the signal path between server 1 and subscriber 2 has been kept free for delay-free signal or data communication.

In accordance with FIG. 3, the server 1 transmits, at an instant TR₁ determined by its timer, the GONG STROKE signal and also subsequently a data packet with the reference time TR₁. The subscriber 2 receives the GONG STROKE signal at the local time TL₁ and stores the reference time TR₁ when the corresponding data packet has been received. Moreover, at an instant TL₂ acquired by the local timer, it transmits to the server 1 an “echo” of the GONG STROKE signal and also subsequently a data packet with the instants TL₁ and TL₂.

The aforementioned echo arrives at the server 1 at an instant TR₂. The server 1 can thus determine the total propagation time S of the aforementioned data packets between server 1 and subscriber 2 and also between subscriber 2 and server 1 as follows:
S=TR₂−TR₁−(TL₂−TL₁)
The server 1 compares the value S with a predefined threshold value ε, which is dimensioned to be so small that both the GONG STROKE signal and the echo must have been communicated without any delays if ε<S<+ε holds true.

If this condition is met, the server 1 transmits to the subscriber 2 the command to adapt the local timer to the reference timer, i.e. to correct the speed of the local timer in accordance with the difference TR₁−TL₁.

If the aforementioned condition is not met, the subscriber 2 receives the command to leave the local timer unchanged.

On account of the relatively high probability that data packets will be communicated between two subscribers without any delays, the aforementioned synchronization can be effected sufficiently frequently to keep the local time TL in close correspondence with the reference time TR.

It should be noted here that the command transmitted by the server 1 to adapt the local timer to the reference timer is permitted to be communicated even with a relatively large delay without causing inaccuracies in the synchronization. Moreover, this synchronization method is very accurate even when the local time TL deviates from the reference time TR to a relatively great extent. This is because this deviation has practically no influence on the determination of S because this only requires the difference between TL, and TL₂.

It is evident from FIG. 4 that estimations and operations effected at the server end in FIG. 3 can also be effected at the subscriber 2.

The speed of the local timer may be altered, in the case of a timer with a crystal-controlled clock generator, on the one hand by altering the frequency of the clock generator. Instead of this, it is also possible to alter the speed by means of software measures, e.g. by assigning an altered number of clock generator pulses to a time unit that is to be predefined or is predefined.

1. A method for the synchronization of local timers of subscribers (2) of a network, with a timer of a subscriber or server (1) that is predefined or predefinable as a reference in the network, which regularly and/or stochastically transmits reference time signals (TR₁) or data packets comprising such signals, it being possible for unforeseeably variable data transmission times to occur in the network, inter alia caused by varying loading and/or an altered structure of the network and of its subscribers, in particular at network nodes, and/or varying signal paths,
a subscriber (2) correcting its local time measurement for adaptation to the time measurement of the reference subscriber or server (1) only when the difference between reference time (TR) and local time (TL), at the instant of reception of the reference time signal, is smaller in magnitude than a predefined or predefinable threshold value (ε) and/or a signal path between subscriber (2) and reference subscriber or server (1) or the network is kept free for delay-free data communication. characterized
in that the time measurement of processors of a process control network is corrected by adapting the speed of the local timer of the respective processor in accordance with the difference between the reference time and the local time that is to be taken into account.

2. The method as claimed in claim 1, characterized
in that the reference subscriber or server (1) transmits to a subscriber (2) or the subscribers, at a reference instant (TR₁), a time signal (GONG STROKE signal) and subsequently a data packet comprising the aforementioned instant (TR₁).

3. The method as claimed in claim 1 characterized
in that the approximation or matching of the local time measurement of the subscriber (2) to the time measurement of the reference subscriber or server (1) is effected by altering the speed of the local time meter of the subscriber (2).

4. The method as claimed in claim 3, characterized
in that the local time meter has a clock generator with a controllable clock frequency that is altered in order to approximate or match the local time measurement to the time measurement of the reference subscriber or server (1).

5. The method as claimed in claim 3, characterized
in that the local time meter has a clock generator and, in order to approximate or match the local time measurement to the time measurement of the reference subscriber or server (1), a time unit that is to be predefined or is predefined is assigned an altered number of clock generator pulses.

6. A method for the synchronization of local timers of subscribers (2) of a network, with a timer of a subscriber or server (1) that is predefined or predefinable as a reference in the network, which regularly and/or stochastically transmits reference time signals (TR₁) or data packets comprising such signals, it being possible for unforeseeably variable data transmission times to occur in the network, inter alia caused by varying loading and/or an altered structure of the network and of its subscribers, in particular at network nodes, and/or varying signal paths, a subscriber (2) correcting its local time measurement for adaptation to the time measurement of the reference subscriber or server (1) only when the difference between reference time (TR) and local time (TL), at the instant of reception of the reference time signal, is smaller in magnitude than a predefined or predefinable threshold value (ε) and/or a signal path between subscriber (2) and reference subscriber or server (1) or the network is kept free for delay-free data communication. characterized
in that the reference subscriber or server (1) transmits to a subscriber (2), at a first instant (TR₁), a time signal (GONG STROKE signal) and subsequently a data packet with the reference time (TR₁)
in that the subscriber detects the local instant (TL₁) of reception of the GONG STROKE signal and transmits an echo of the GONG STROKE signal to the reference subscriber or server at a later local instant (TL₂),
in that the reference subscriber or server (1) detects the instant (TR₂) of reception of the echo,
in that the sum of the difference between the first-mentioned local instant (TL₁) and the first-mentioned reference instant (TR₁) and the difference between the latter reference instant (TR₂) and the later local instant (TL₂) is determined,
in that a check is made to determine whether the magnitude of said sum lies below a small threshold value (ε), and
in that it is only when this condition is met that the local time measurement of the subscriber (2) is approximated or matched to the time measurement of the reference subscriber or server.

7. The method as claimed in claim 1, characterized
in that subscribers output an error signal (“time error”) if synchronization has not been effected within a predefinable time interval or after a predefinable number of synchronization attempts.

8. The method as claimed in claim 1, characterized
in that each subscriber, for synchronization-dependent functions, undergoes transition to an operationally ready state or signals operational readiness only after synchronization has been effected.

9. The method as claimed in claim 1, characterized
in that a crystal-controlled clock generator is used.

10. The method as claimed in claim 1, characterized
in that the speed of the local timer is adapted by altering the frequency of a crystal-controlled clock generator and/or by assigning an altered number of clock generator pulses to a time unit that is to be predefined or is predefinable.

11. The method as claimed in claim 6, characterized
in that subscribers output an error signal (“time error”) if synchronization has not been effected within a predefinable time interval or after a predefinable number of synchronization attempts.

12. The method as claimed in claim 6, characterized
in that each subscriber, for synchronization-dependent functions, undergoes transition to an operationally ready state or signals operational readiness only after synchronization has been effected.

13. The method as claimed in claim 6, characterized
in that the speed of the local timer is adapted by altering the frequency of a crystal-controlled clock generator and/or by assigning an altered number of clock generator pulses to a time unit that is to be predefined or is predefinable.

14. The method as claimed in claim 1, characterized
in that the reference subscriber or server (1) transmits to a subscriber (2), at a first instant (TR₁), a time signal (GONG STROKE signal) and subsequently a data packet with the reference time (TR₁)
in that the subscriber detects the local instant (TL₁) of reception of the GONG STROKE signal and transmits an echo of the GONG STROKE signal to the reference subscriber or server at a later local instant (TL₂),
in that the reference subscriber or server (1) detects the instant (TR₂) of reception of the echo,
in that the sum of the difference between the first-mentioned local instant (TL₁) and the first-mentioned reference instant (TR₁) and the difference between the latter reference instant (TR₂) and the later local instant (TL₂) is determined,
in that a check is made to determine whether the magnitude of said sum lies below a small threshold value (ε), and
in that it is only when this condition is met that the local time measurement of the subscriber (2) is approximated or matched to the time measurement of the reference subscriber or server.
